(19) United States
(12) Patent Application Publication
(10) Pub. No.: US 2018/0125300 A1
(43) Pub. Date: May 10, 2018

(54) APPARATUS AND METHOD FOR GRINDING COFFEE BEANS

(71) Applicants: Craig Robert Lyn, Los Angeles, CA (US); Douglas Weber, San Francisco, CA (US)

(72) Inventors: Craig Robert Lyn, Los Angeles, CA (US); Douglas Weber, San Francisco, CA (US)

(73) Assignee: Strategic Exits LLC, Los Angeles, CA (US)

(21) Appl. No.: 15/344,685

(22) Filed: Nov. 7, 2016

(51) Int. Cl. A47J 42/26; A47J 42/50; A47J 42/40

(52) U.S. Cl. CPC A47J 42/26; A47J 42/40; A47J 42/50

(57) ABSTRACT

A device for grinding coffee beans one shot at a time. The device may consist of an inlet funnel attached to a main body, wherein the beans are gravity fed to a set of burrs that grind the coffee into a grounds chamber, where they are then expunged into a grounds receptacle. The grounds receptacle may be adjusted in height via arms attached to the grinder depending on the workflow of the user and the type of receptacle being used. The grounds chamber is a clamshell design easily removable by the user for cleaning and held in place with magnets and alignment pins. As the grinder grinds coffee, wipers on the mounts for the burr create a positive pressure air flow to expunge the ground beans in addition to physically manipulating them out of the exit chute. This allows for grinding and expulsion of all of the input coffee without retention, a common problem in the industry when grinders are used for single shot grinding.

### FIELD OF THE INVENTION

The present disclosure relates generally to grinders for preparing coffee beans for café beverages.

### BACKGROUND

Prior art in this field provides room for improvement. Similar issues plague many commercial coffee grinders available today. Grinders are difficult and time consuming to clean. The grinding burrs are often buried deep inside the casings of the machines. Cleaning and servicing requires hours if not days of costly downtime, as well as specialized technicians. Alignment of the burr sets, which is crucial to providing coffee grounds that have uniform granular size characteristics, is next to impossible to achieve since this feature was not factored into the original design of the machines. Through poor design, many grinders retain a large portion of grounds inside of the machine after operation. Retained coffee grounds inside a machine quickly become rancid, thereby negatively impacting the coffee product. Moreover, this can be a health hazard.

The object of this invention is to provide a commercial barista with an easy to use, easy to clean, and highly controllable coffee grinder to help produce a quality product. This invention has specific traits that contribute to this result.

The invention is simple for the user to both verify and adjust burr alignment. Without the use of any tools, the burr set is fully accessible easily and quickly to facilitate both regular maintenance and daily cleaning. If necessary, adjustments to burr alignment can be made without having to dis-assemble the grinder.

This invention provides incredible accuracy in portion control and is therefore ideal for situations where multiple roasts need to be ground on the same machine, with less chance of residual grounds from one roast impacting the results of another. It has been designed as a single dosing grinder with near zero grind retention because it offers minimal contact between the ground product and the surface of the grinder.

The invention makes the cleaning process easy offering more options for using different roast in high volume environments or in other service situations such as cupping rooms or roasting labs. The grind chamber can be opened, thoroughly cleaned and re-assembled very quickly. The top and bottom funnel caps easily snap off the front of the unit, providing the barista with complete and unobstructed access to the burr set and wiper system. The upper dosing dish can be quickly uncoupled from the grinder for a quick wipe down.

### BRIEF DESCRIPTION OF THE DRAWINGS

Embodiments will now be described with reference to the following drawings, which are provided by way of example, and not limitation.

FIG. 1 is a front and right picture view of a conventional coffee grinder to describe prior art.

FIG. 2 is a right picture view of grinder showing the basic architecture and orientation of main features.

FIG. 3 is an isometric view of the detail of a rail system for affixing a portafilter or other receptacle under the grounds orifice of the grinder.

FIG. 4 is an isometric view and detailed isometric view of the bean entry point into the grinder, herein referred to as the ‘bean dish.’

FIG. 5 is an isometric view and detailed isometric view of the locking ring mechanism for the grinder's coarseness adjustment.

FIG. 6 is an isometric cross-sectional view of the locking ring mechanism showing the placement of embedded magnets to retain the ring in one of two axial positions. These can be referred to as the ‘locked position’ with the pins (b) engaged, and the ‘unlocked position’ where the magnets hold the ring above the pins so the user can freely adjust the grind coarseness.

FIG. 7 is an isometric view and detailed isometric view of the wipers and blades inside the grinds chamber of the grinder. The funnel cover pieces have been removed to expose the wiper and blades portion of this mechanism.

FIG. 8 is an isometric view showing the main components of the burr alignment mechanism.

FIG. 9 is a front isometric view and detailed front isometric view showing the bearing plate of the alignment mechanism and the 2 axes of burr alignment.

FIG. 10 is an isometric view and detailed isometric view of the funnels that create the grind chamber. The locking magnets and alignment pins are shown here.

FIG. 11 is an isometric view of the funnels separated from the grinder to show the details of the magnets and alignment pin bearings.

FIG. 12 is a top front view with the funnels removed to show the main components of the grind mechanism.

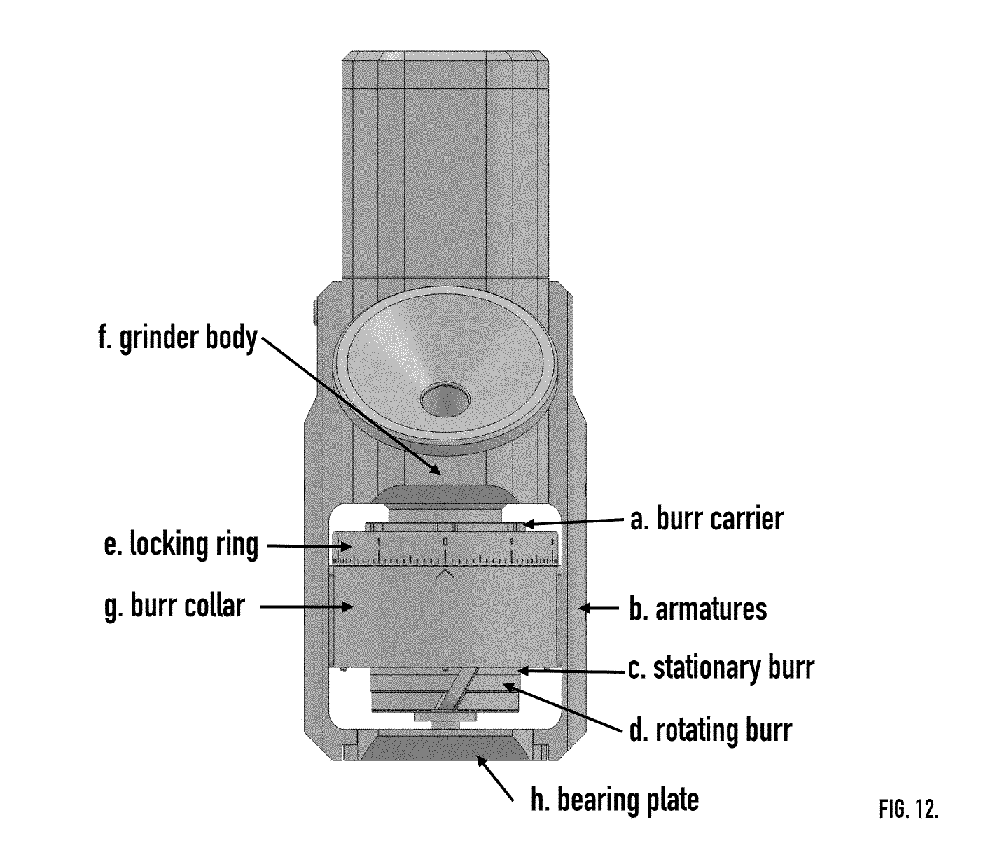

### DETAILED DESCRIPTION

In general, the present disclosure relates to a precise and accurate countertop coffee bean grinding and dispensation system that outputs a precise dose of ground coffee beans based on the initial weight or mass fed into the machine.

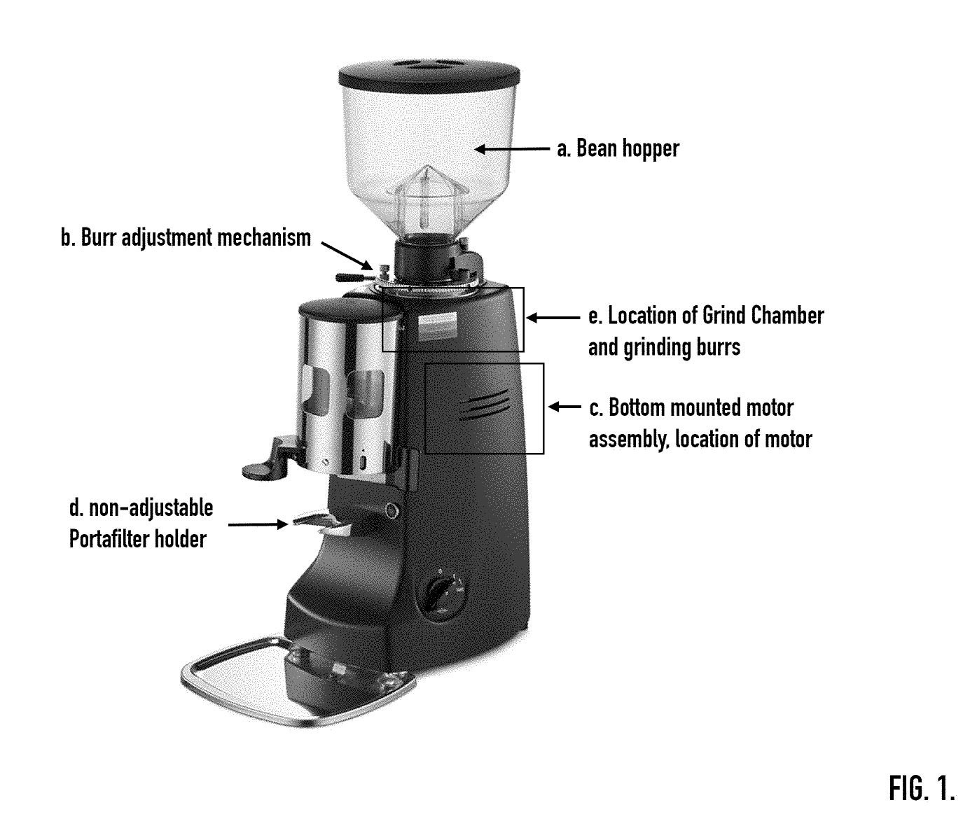

FIG. 1. Illustrates a conventional fixed burr speed coffee grinder, with a top mounted bean hopper dosing apparatus (FIG. 1.a) which stores coffee beans in a non-hermetically sealed container which allow for oxidation and spoilage; coarse spring loaded burr adjustment mechanism (FIG. 1.b) which leads to misalignment of the grinding burrs; bottom mounted motor assembly (FIG. 1.c) which locates ground coffee and stored coffee directly over a high heat source which is the motor, which leads to spoilage; non-adjustable portafilter holder (FIG. 1.d) which limits the barista to specific receptacles which can be used with the grinder and does not offer hands free operation; inaccessible grind chamber (FIG. 1.e) which provides for non-adjustable burr alignment, difficulty cleaning and servicing, with high coffee ground retention typical of the prior art in this technical field.

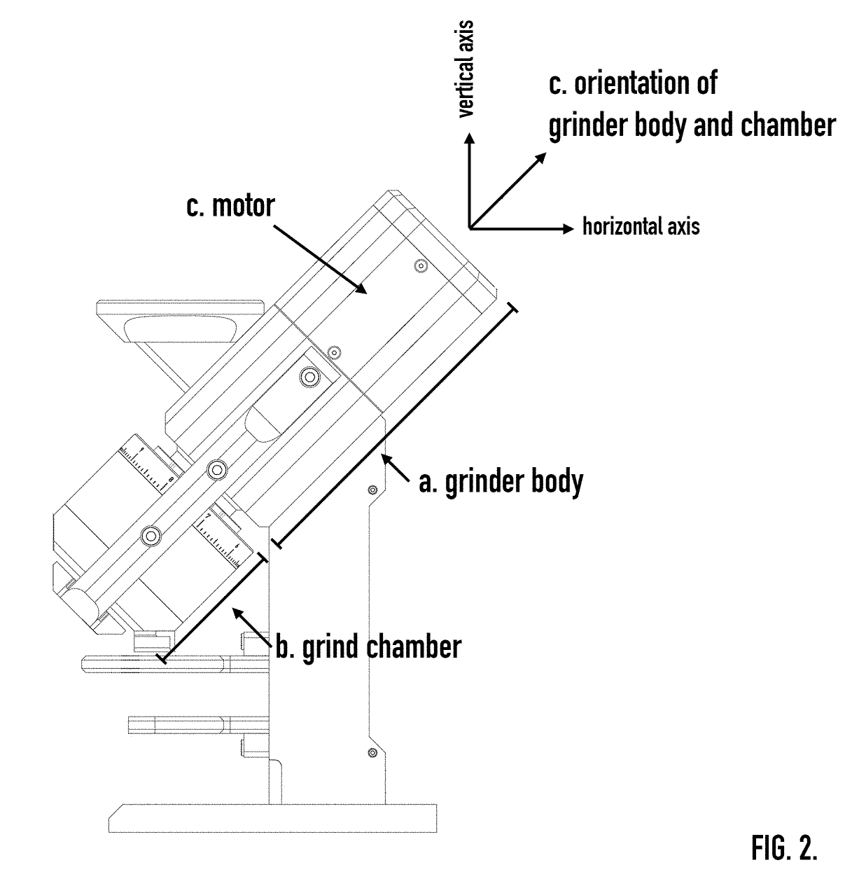

FIG. 2. Illustrates a side view of an embodiment of the coffee bean grinder, wherein the grinder body (FIG. 2.a) and grind chamber (FIG. 2.b) are oriented in between (FIG. 2.c) the horizontal and vertical axis, and the motor (FIG. 2.c) is located above the grind chamber (FIG. 2.b) which houses the grinding burrs. By mounting the motor above the grind chamber, heat generated from the operation of the motor does not affect the quality of the ground coffee since it dissipates above and away from the burrs. By mounting the grinder at an angle in between the vertical and horizontal, beans can be fed into the grind chamber using gravity. The burrs also operate at a lower RPM, not requiring the higher RPMs associated with a vertical orientation which require centrifugal force to feed the beans into the cutting surfaces. With lower RPMs, less heat via friction is introduced into the ground coffee preventing spoilage.

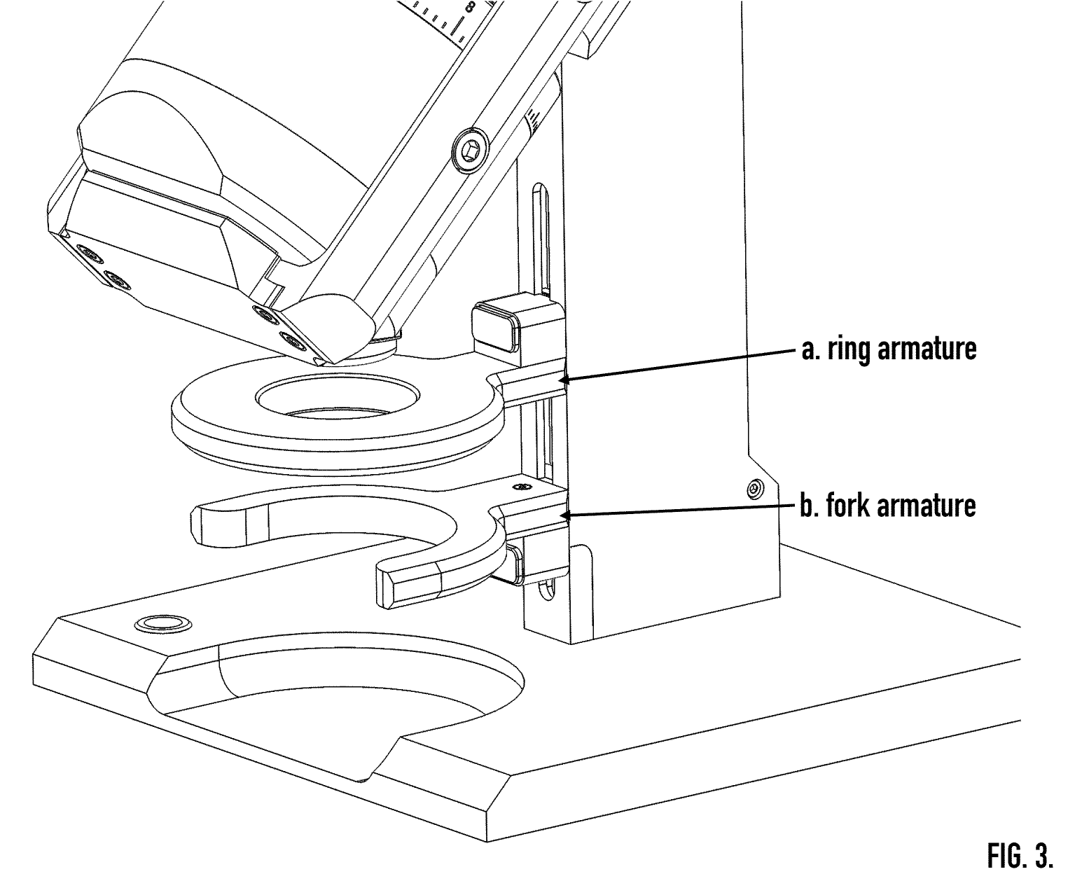

FIG. 3. Illustrates a front and right view of an embodiment of the coffee bean grinder, wherein a set of armatures, used independently or in tandem (FIG. 3.a/3.b) can be vertically translated to hold a variety of sized and shaped receptacles to contain ground coffee. The armatures can be arranged as to provide hands free operation increasing worker efficiency.

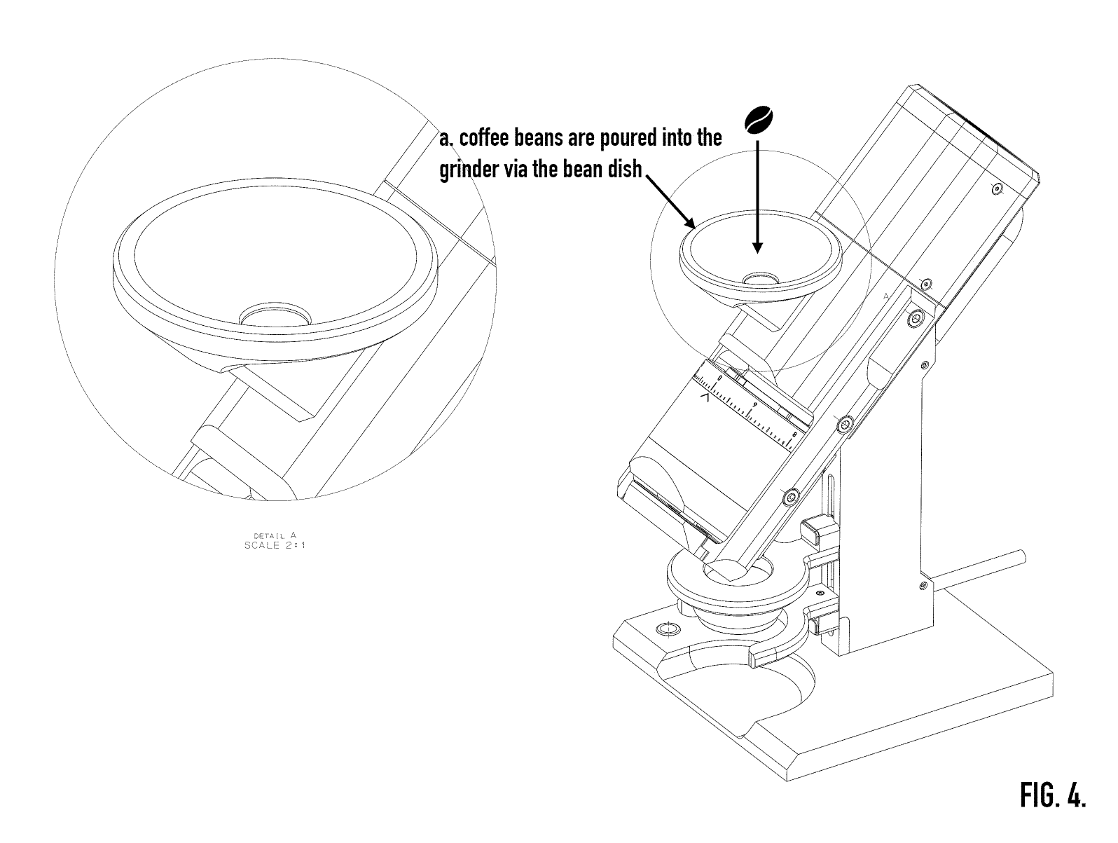

FIG. 4. Illustrates a front and right view of an embodiment of the coffee bean grinder, wherein pre-measured doses of coffee beans are loaded into the grinder through a bean dish (FIG. 4.a). Coffee is stored independent to the grinder, reducing spoilage.

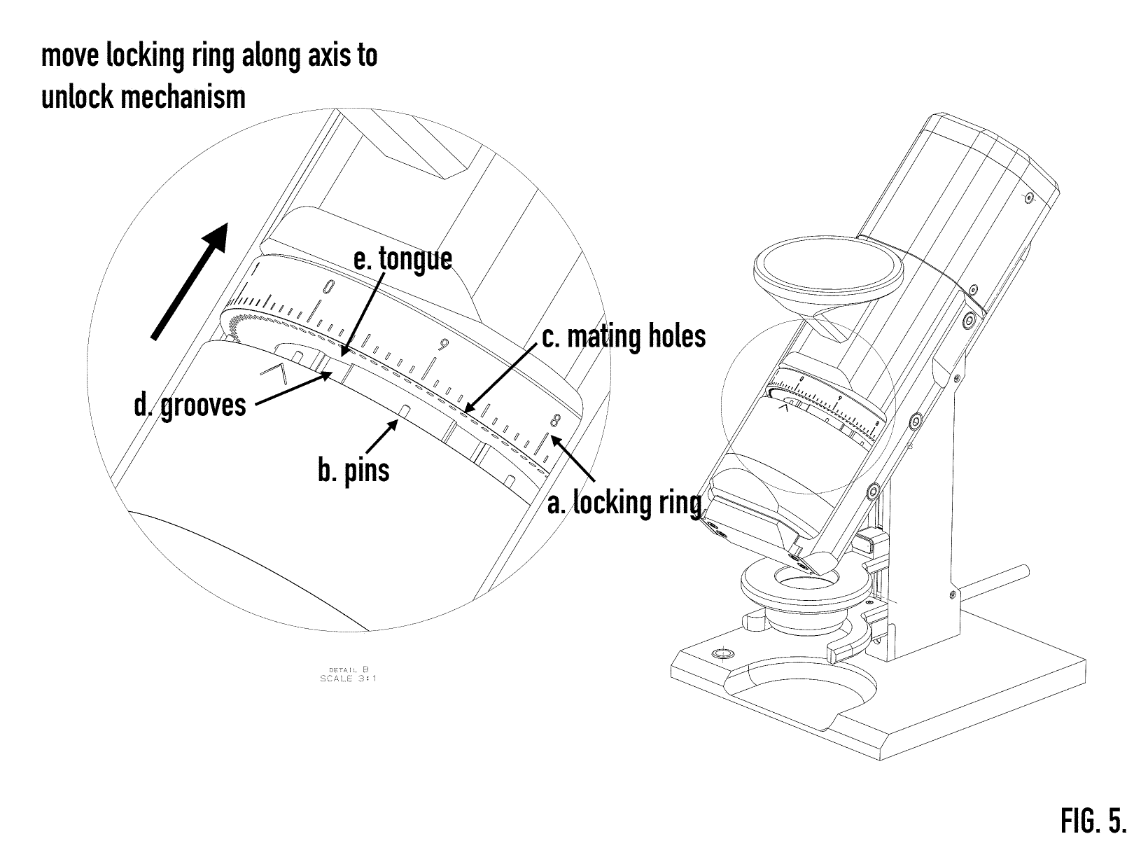

FIG. 5. Illustrates a front and right view of an embodiment of the coffee bean grinder, wherein the adjustment mechanism for the grinding burrs utilizes a locking ring (FIG. 5.a) mechanism. The locking ring (FIG. 5.a) is shown at full vertical translation, unlocking the mechanism so as to adjust the grind.

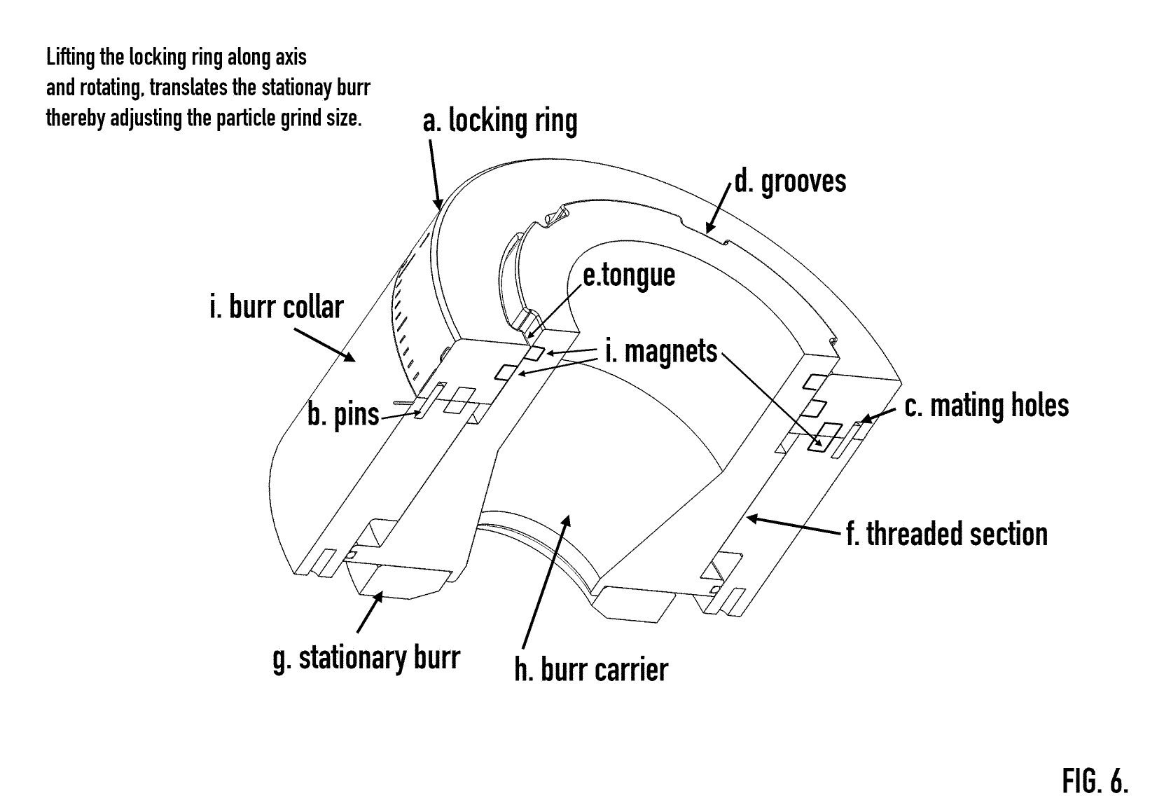

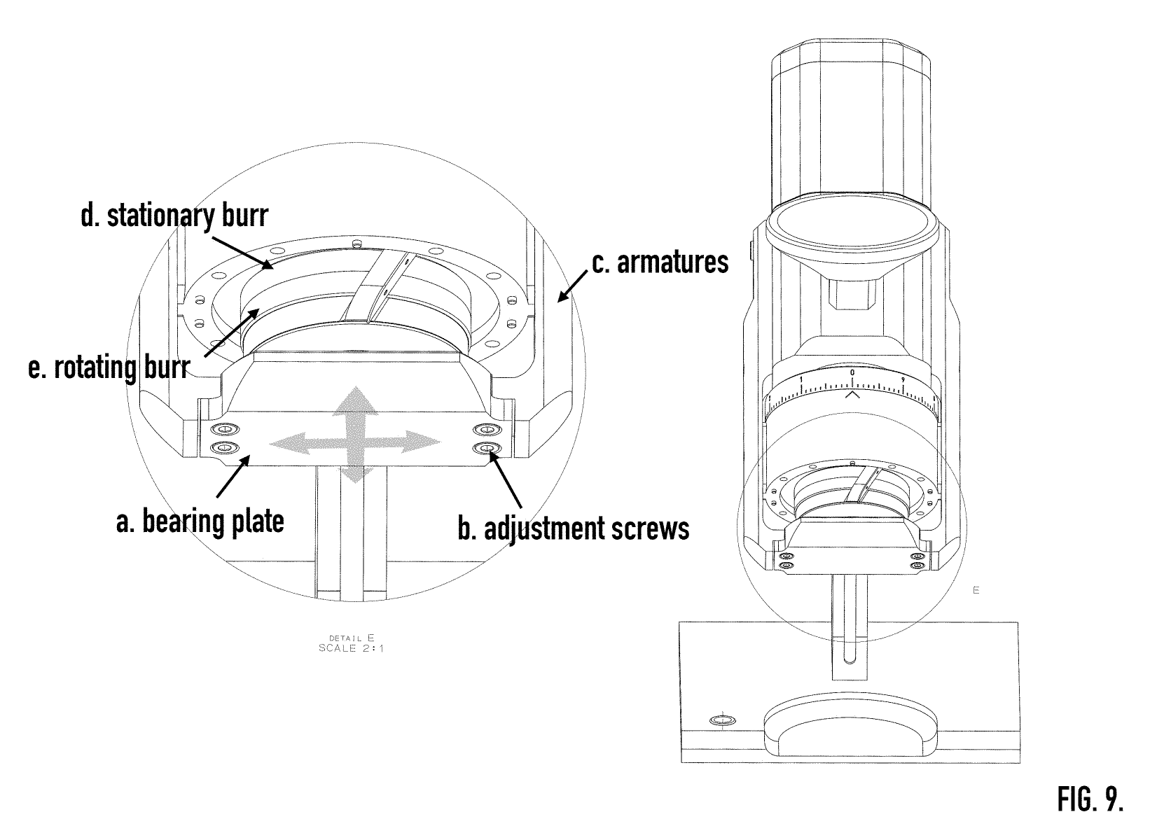

FIG. 6. Illustrates an isolated cross section of an embodiment of the coffee bean grinder, wherein the adjustment mechanism for the grinding burrs utilizes a locking ring mechanism. In general, coffee grinder burrs come in sets of two, and utilize one stationary or non-rotating burr and one rotating burr. The distance, along the axis, between the stationary and non-rotating burr determines the granule size of the ground coffee. In this embodiment of the coffee grinder, lifting the locking ring (FIG. 6.a) along axis and rotating, translates the burr carrier (FIG. 6.h) thereby adjusting the particle grind size. The burr carrier (FIG. 6.h) is mounted inside the burr collar (FIG. 6.i) and allows for vertical translation via a threaded section (FIG. 6.f). The tongues (FIG. 6.e) in the locking ring (FIG. 6.a) engage in the grooves (FIG. 6.d) inside the burr carrier locking rotational movement but allow for vertical translation. When the pins (FIG. 6.b) in the burr carrier (FIG. 6.h) are engaged with the mating holes (FIG. 5.c) in the locking ring (FIG. 6.a), the burr carrier (FIG. 6.h) can not rotate freely. Sets of magnets (FIG. 6.l) located in both the burr carrier (FIG. 6.h) and locking ring (FIG. 6.a) hold the locking ring (FIG. 6.a) stationary when translating the locking ring (FIG. 6.a) vertically for grind adjustment and when adjustments are complete. The tongue and groove system in combination with the locking pins does not introduce any axial deflection, which maintains concentricity of the stationary burr (FIG. 9.d) and the rotating burr (FIG. 9.e) which is crucial for quality coffee grounds.

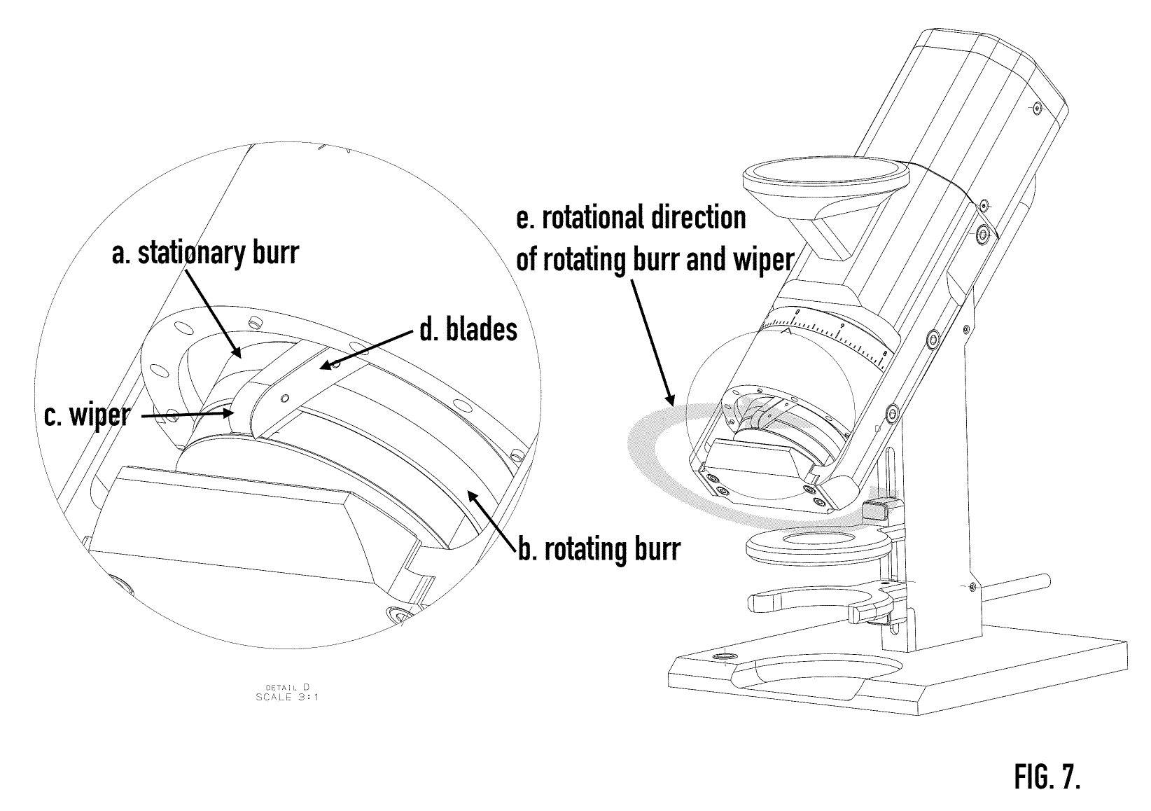

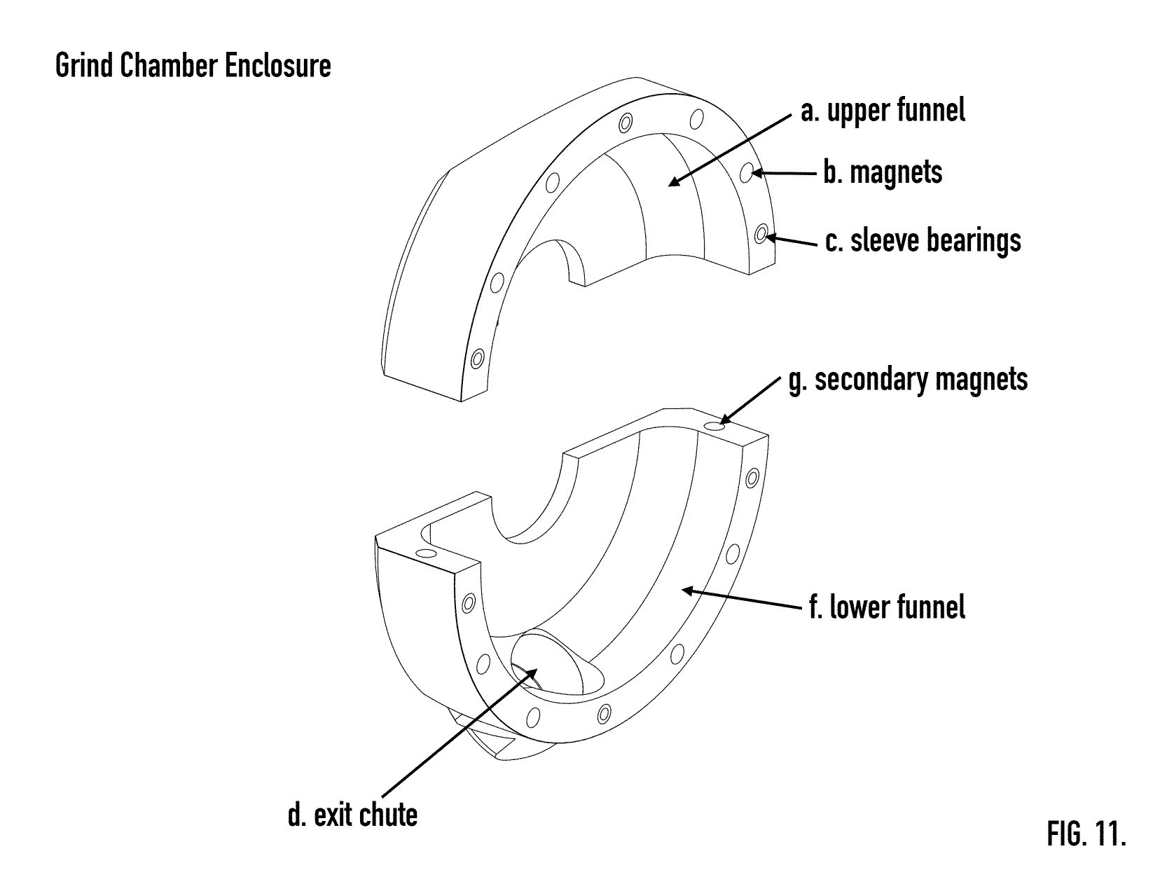

FIG. 7. Illustrates a front and right view of an embodiment of the coffee bean grinder, wherein the stationary burr (FIG. 7.a) upper funnel (FIG. 11.a) and lower funnels (FIG. 11.f) are cleaned as the blades (FIG. 7.d) rotate and wipe the surface. The angle of the wiper creates a positive air pressure region inside the grind chamber, expunging any remaining grounds out of the exit chute (FIG. 11.e). The sweeping action of the blades reduces ground retention and spoilage inside the grinder and increases the accuracy of a weighted dose.

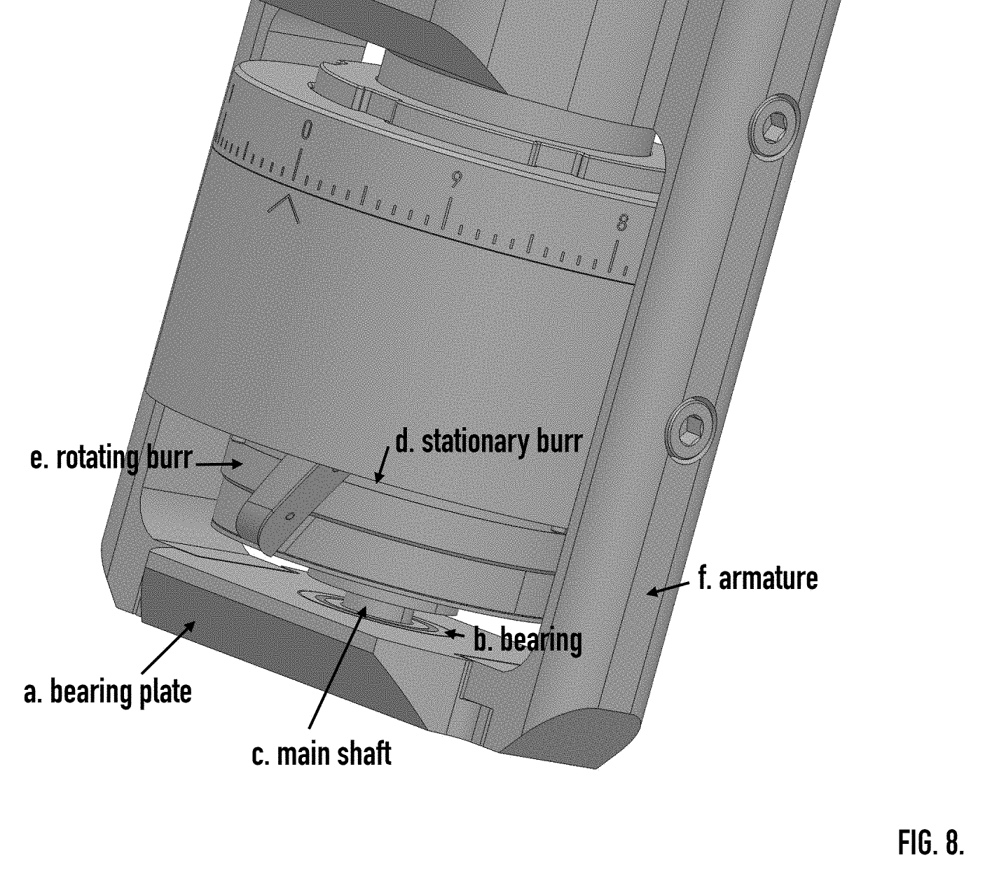

FIG. 8. Illustrates a top and right view of an embodiment of the coffee bean grinder, wherein the main shaft (FIG. 8.a) upon which the rotating burr (FIG. 8.e) is mounted, is axially mounted to a bearing (FIG. 8.b) secured into a bearing plate (FIG. 8.a).

FIG. 9. Illustrates a front view of and embodiment of the coffee bean grinder, wherein the bearing plate (FIG. 9.a) is attached to the armatures (FIG. 9.c) by a set of adjustment screws (FIG. 9.c). The bearing plate (FIG. 9.c) can be translated in a planar direction to adjust the concentricity of the rotating burr (FIG. 9.e) and stationary burr (FIG. 9.d). Burr concentricity or parallelism is paramount when grinding coffee as to provide a uniform grind size.

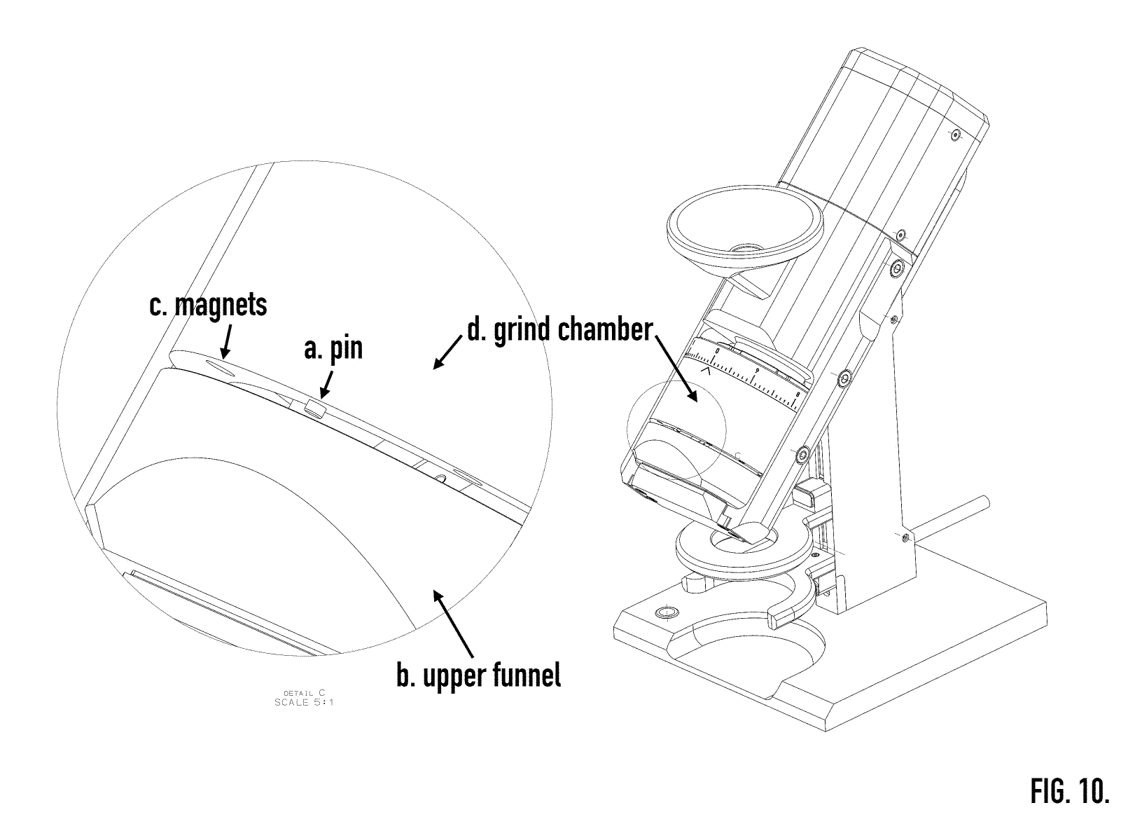

FIG. 10. Illustrates of top and right view of an embodiment of the coffee bean grinder, wherein the stationary burr (FIG. 7.a) rotating burr (FIG. 7.b) and wiper (FIG. 7.c) are enclosed within a lower funnel (FIG. 11.f) and upper funnel (FIG. 10.b). The upper funnel is aligned to the grind chamber (FIG. 10.d) with a set of pins (FIG. 10.a) and sleeve bearings (FIG. 11.c) and held stationary to the grind chamber (FIG. 10.d) with magnets (FIG. 10.c) also mounted in the upper and lower funnels (FIG. 11.b).

FIG. 11. Illustrates an embodiment of the coffee bean grinder wherein the upper funnel (FIG. 11.a) and lower funnel (FIG. 11.f) utilize secondary magnets (FIG. 11.g) to form a strong holding bond with the opposite funnel. The funnel arrangement allows for quick access to the critical parts of the grinder which aids in servicing, alignment and cleaning.

We claim:

1. A coffee bean grinder comprising of a motor mounted above rather than below the grinding burrs, and angled in between a horizontal and vertical axis.

2. A coffee bean grinder comprising of a motor mounted above rather than below the grinding burrs, with the motor situated directly vertically above the burrs.

3. An adjustable rail system that can accommodate a variety of different sized and shaped coffee ground receptacles.

4. The adjustable rail system of claim 3, wherein the main armature is a circular platform with a hole.

5. The adjustable rail system of claim 3, wherein the main armature is a U-shaped piece fitted to standard espresso portafilters.

6. The adjustable rail system of claims 3, 4 and 5, wherein the circular and U-shaped armatures can be adjusted in overall and relative height.

7. A dosing funnel attached to the body of the grinder which enables the grinding of pre-defined doses of coffee.

8. A precise and repeatable locking ring for the burr sets that maintains concentricity of the burr sets and locks in place with magnets. A grind adjustment mechanism wherein the adjustment is made with mated threaded housings that encase the upper and lower burrs, and wherein the grind adjustment is rotationally locked in place with fitted pins and holes in a locking ring.

9. The locking ring mechanism of claim 8, wherein the locking ring utilizes magnets to create bistable positioning of the ring to either be locked or unlocked.

10. A wiping mechanism that cleans the inside of the grind chamber and burrs and also provides a positive internal pressure that forces retained grounds out of the machine. A burr carrier that incorporates wiping blades to constantly expunge ground coffee out of the grind chamber of the machine.

11. The wiping blades of claim 10, wherein the wiping blades are angled such that while spinning they create both a vacuum pressure to pull grounds through the burrs and a positive fan pressure to expunge grounds from the grind chamber.

12. A 2-part clamshell grinding chamber that is held together and to the body of the grinder using a set of magnets and aligned with pins and sleeve bearings.

13. A floating, adjustable plate with a bearing that holds the main shaft of one of the burrs of a coffee grinder, wherein the plate can be fixed in place with bolts to adjust the relative concentricity of the burrs separate from the rest of the machine tolerances.
